(19) United States
(12) Patent Application Publication
(10) Pub. No.: US 2022/0293522 A1
(43) Pub. Date: Sep. 15, 2022

(54) Buried Power Rail Architecture

(71) Applicant: Arm Limited, Cambridge (GB)

(72) Inventors: Sriram Thyagarajan, Austin, TX (US); Ettore Amirante, Nice (FR); Andy Wangkun Chen, Austin, TX (US); Yew Keong Chong, Austin, TX (US); Sony ., Noida (IN)

(21) Appl. No.: 17/199,143

(22) Filed: Mar. 11, 2021

(51) Int. Cl. H01L 23/528; G06F 30/3953; H01L 23/522; G06F 119/06

(52) U.S. Cl. CPC H01L 23/5286; G06F 30/3953; H01L 23/5226; G06F 2119/06

(57) ABSTRACT

Various implementations described herein are directed to a method for routing buried power rails underneath a memory instance. The method may identify first rails of the buried power rails disposed in a first layer and second rails of the buried power rails disposed perpendicular to the first rails in a second layer. The method may identify long rails of the first rails with a first length and short rails of the first rails with a second length that is less than the first length. The method may separately couple the long rails and the short rails to the second rails with vias that extend between the first layer and the second layer.

### BACKGROUND

This section is intended to provide information relevant to understanding various technologies described herein. As the section's title implies, this is a discussion of related art that should in no way imply that it is prior art. Generally, related art may or may not be considered prior art. It should therefore be understood that any statement in this section should be read in this light, and not as any admission of prior art.

In conventional circuit designs, metal routing of power/ground tracks belonging to memory instances may fail or could likely become inefficient due to lack of placement priority among different power domains present in memory instances. In general, conventional metal routing typically involves increased minimum lengths of power/ground tracks inside memory instances. Also, in reference to modern circuit designs, it should be considered important to overcome deficiencies of metal routing lines among memory power/ground tracks along with improving placement of global power/ground nets for routing critical signals. There exists a need to improve efficiency of critical power/ground nets in modern circuit designs.

### BRIEF DESCRIPTION OF THE DRAWINGS

Implementations of various memory layout schemes and techniques are described herein with reference to the accompanying drawings. It should be understood, however, that the accompanying drawings illustrate only various implementations described herein and are not meant to limit embodiments of various techniques described herein.

FIGS. 1-2 illustrate diagrams of various power distribution network architecture with buried power rails in accordance with implementations described herein.

FIGS. 3-4 illustrate diagrams of various methods for providing buried power rail architecture with buried metal in accordance with implementations described herein.

FIG. 5 illustrates a system for providing buried power rail architecture in physical design in accordance with various implementations described herein.

### DETAILED DESCRIPTION

Various implementations described herein are directed to buried power rail layout schemes and techniques for logic and memory applications in physical design. For instance, the various schemes and techniques described herein may provide for enhanced routing of buried metal for power and/or ground tracks belonging to memory instances. Also, the buried power rail layout schemes and techniques described herein may be configured to provide for routing critical signals in buried backside metal layers and also routing global signal nets in buried backside metal layers. Further, the buried power rail layout schemes and techniques described herein may avoid routing complexity and also allow power, ground and/or various critical signals to be routed with increased width for improved performance.

In various implementations, the buried power rail layout schemes and techniques described herein provide for a novel power distribution network architecture in physical layout design for improved placement priority. As described in greater detail herein below, a method for buried power rail layout design provide for enhanced routing of buried metal power/ground tracks belonging to memory instances. For instance, various methods described herein may provide for identification of short power tracks in a buried metal layer along with insertion of buried connections in other buried metal layers. In various instances, if power porosity is not requested, then enhancement of buried metal power/ground net is achievable. Otherwise, if power porosity is requested, then user-defined power grid enhancements may be utilized to determine whether implementation of porosity along with enhanced routing of buried metal power/ground is achievable. In some instances, graphical user interface (GUI) options may be utilized to support power routing for adjusting memory related power/ground tracks to form wide empty channels that are suitable to support power routing that seeks to exploit porosity available in one or more of buried metal layers. In other instances, other GUI options may be utilized to support signal routing for customization of memory related power/ground tracks so as to create shielded routing channels that are suitable to support signal routing. Further, the method may be automated so as to improve efficiency and avoid human error.

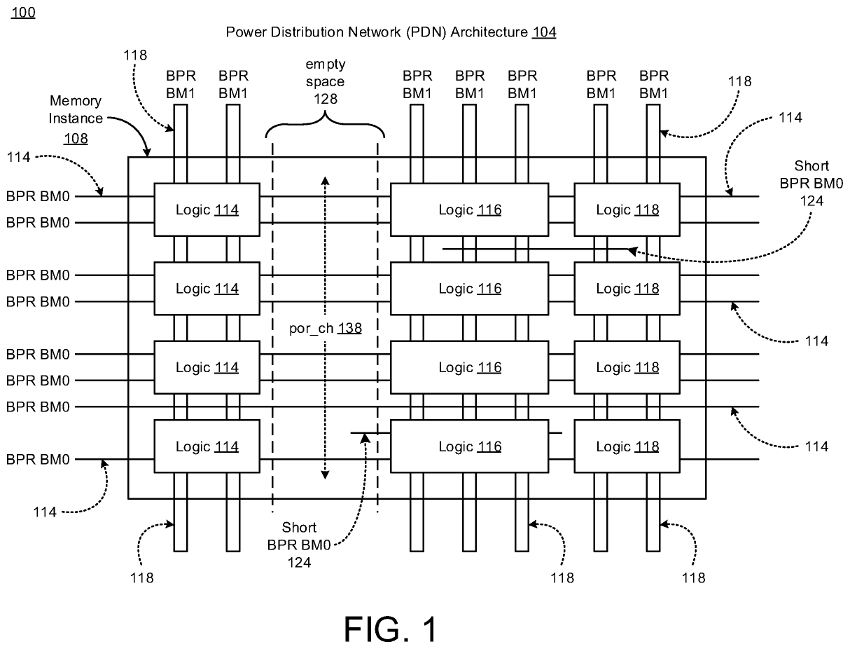

Various implementations of providing backside power rail architecture with buried metal layers will be described herein with reference to FIGS. 1-5.

FIG. 1 illustrates a diagram 100 of power distribution network (PDN) architecture 104 having buried power rails in accordance with implementations described herein.

In various implementations, the PDN architecture 104 may be implemented as a system or a device having various integrated circuit (IC) components that are arranged and coupled together as an assemblage or combination of parts that provide for physical circuit designs and various related structures. In some instances, a method of designing, providing and/or fabricating the PDN architecture 104 as an integrated system or device may involve use of various IC circuit components described herein so as to implement various fabrication schemes and techniques associated therewith. Moreover, the PDN architecture 104 may be integrated with computing circuitry and various related components on a single chip, and the PDN architecture 104 may be implemented and incorporated in various embedded systems for automotive, electronic, mobile, server and Internet-of-things (IoT) applications.

As shown in FIG. 1, the PDN architecture 104 may include a memory instance 108 and a power distribution network (PDN) having buried power rails (BPR) 114, 118 that are routed underneath the memory instance 108. In some instances, the buried power rails (BPR) 114, 118 may include first rails 114 that are disposed in a first layer (BM0) and second rails 118 that are disposed perpendicular to the first rails 114 in a second layer (BM1). Also, the first rails 114 may have long rails 114 with a first length and short rails 124 with a second length that is less than the first length. Further, the long rails 114 and the short rails 124 may be separately coupled to the second rails 118 with vias that are configured to extend between the first layer (BM0) and the second layer (BM1). In various implementations, the first rails 114 may be configured with a first width, and the second rails 124 may be configured with a second width that is greater than the first width.

As also shown in FIG. 1, the PDN architecture 104 may have one or more logic circuits 114, 116, 118 that are disposed (or formed) above the buried power rails (BPR) 114, 118, 124. In reference to a physical layout design, the PDN architecture 104 may have empty space 128 that is formed between one or more of the logic circuits, such as, e.g., between logic circuits 114 and logic circuits 116. In various instances, the empty space 128 provided in the PDN architecture 104 may refer to porosity associated with the PDN architecture 104, which may also refer to a porosity channel (por_ch) 138 that may be formed between one or more of the logic circuits, such as, e.g., 114 and 116.

In some implementations, the PDN architecture 104 may be configured to provide the memory instance 108 as a static random access memory (SRAM) instance, which may have access ports controlled by wordlines (WL, RWL) and bitlines (BL, NBL, RBL). In some instances, SRAM bitcells may be implemented with 8T multi-port bitcells; however, various other types of multi-transistor bitcells may be used, such as, e.g., 2T, 4T, 6T, 10T, etc. Also, in various instances, the transistors may refer to P-type field effect transistor (PFET) devices, and/or N-type field effect transistor (NFET) devices. Moreover, the multi-access port devices may be varied within the 8T multiple-port bitcell such that some access devices (by port) are PFET devices and some access devices by port are NFET devices.

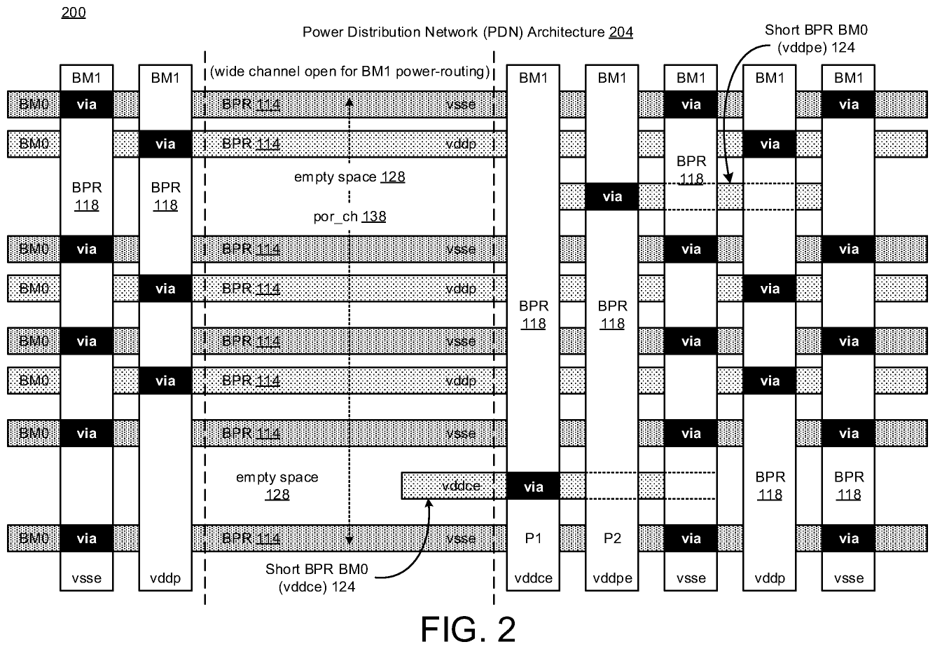

FIG. 2 illustrates a diagram of power distribution network (PDN) architecture 204 having buried power rails in accordance with implementations described herein. In reference to FIG. 2, the PDN architecture 204 provides an implementation of buried metal routing of power/ground nets for a memory instance that supports porosity for power-routing. In various instances, various features and components shown and described herein in reference to the PDN architecture 204 of FIG. 2 are similar in scope and function as described in reference to the PDN architecture 104 in FIG. 1.

In various implementations, the PDN architecture 204 may be implemented as a system or a device having various integrated circuit (IC) components that are arranged and coupled together as an assemblage or combination of parts that provide for physical circuit designs and various related structures. In some instances, a method of designing, providing and/or fabricating the PDN architecture 204 as an integrated system or device may involve use of various IC circuit components described herein so as to implement various fabrication schemes and techniques associated therewith. Moreover, the PDN architecture 204 may be integrated with computing circuitry and various related components on a single chip, and the PDN architecture 204 may be implemented and incorporated in various embedded systems for automotive, electronic, mobile, server and Internet-of-things (IoT) applications.

As shown in FIG. 2, the PDN architecture 204 may include the power distribution network (PDN) having the buried power rails (BPR) 114, 118, 124. In various instances, the buried power rails (BPR) 114, 118, 124 may include the first rails 114, 124 disposed in the first layer (BM0) and the second rails 118 disposed perpendicular to the first rails 114, 124 in the second layer (BM1). As described herein, the first rails 114 may have the long rails 114 with a first length and the short rails 124 with a second length that is less than the first length. Also, the long rails 114 and the short rails 124 may be separately coupled to the second rails 118 with vias (via) that are configured to extend between the first layer (BM0) and the second layer (BM1). The first rails 114 may be configured with a first width, and the second rails 124 may be configured with a second width that is greater than the first width.

In some implementations, the PDN architecture 204 may be arranged in a physical layout design, wherein the PDN architecture 204 may include the empty space 128 disposed (or formed) between the second rails 118. The empty space 128 may refer to a porosity that is associated with the PDN architecture 204, which may refer to the porosity channel (por_ch) 138 that is formed between the second rails 118.

In various implementations, a first set of the long rails 114 disposed (or formed) in the first layer (BM0) may be coupled to ground (vsse), and a second set of the long rails 114 disposed (or formed) in the first layer (BM0) may be coupled to a first supply (vddp). Also, a first set of the short rails 124 disposed (or formed) in the first layer (BM0) may be coupled to a second supply (vddce), and a second set of the short rails 124 disposed (or formed) in the first layer (BM0) may be coupled to a third supply (vddpe).

In various implementations, a first set of the second rails 118 disposed (or formed) in the second layer (BM1) may be coupled to ground (vsse) by way of at least one via (via) coupled to the first set of the long rails 114 in the first layer (BM0). Also, a second set of the second rails 118 disposed (or formed) in the second layer (BM1) may be coupled to the first supply (vddp) by way of at least one other via (via) coupled to the second set of the long rails 114 in the first layer (BM0). Also, a third set of the second rails 118 disposed (or formed) in the second layer (BM1) may be coupled to the second supply (vddce) by way of at least one via (via) coupled to the first set of the short rails 124 in the first layer (BM0). Further, a fourth set of the second rails 118 disposed (or formed) in the second layer (BM1) may be coupled to the third supply (vddpe) by way of at least one other via (via) coupled to the second set of the short rails 124 in the first layer (BM0).

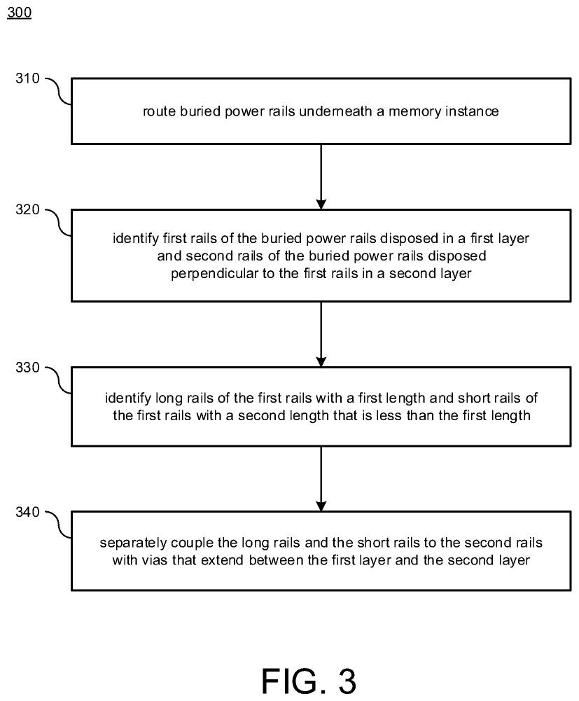

FIG. 3 illustrates a process diagram of a method 300 for providing buried power rail architecture with buried metal in accordance with implementations described herein.

It should be understood that even though method 300 indicates a particular order of operation execution, in some cases, various portions of operations may be executed in a different order, and on different systems. In other cases, additional operations and/or steps may be added to and/or omitted from method 300. Also, method 300 may be implemented in hardware and/or software. If implemented in hardware, method 300 may be implemented with components and/or circuitry, as described in reference to FIGS. 1-2. If implemented in software, method 300 may be implemented as a program or software instruction process configured for providing PDN architecture with buried power rails, as described herein. Also, if implemented in software, instructions related to implementing method 300 may be stored in memory and/or a database. For instance, a computer or various other types of computing devices having a processor and memory may be configured to perform method 300.

As described in reference to FIG. 3, the method 300 may be used for fabricating and/or manufacturing, or causing to be fabricated and/or manufactured, an integrated circuit (IC) that implements the various buried power rail layout schemes and techniques in physical design as described herein so as to thereby provide PDN architecture with buried power rails using various associated devices, components and/or circuitry as described herein.

At block 310, method 300 may route buried power rails underneath a memory instance. At block 320, method 300 may identify first rails of the buried power rails disposed in a first layer (BM0) and second rails of the buried power rails disposed perpendicular to the first rails in a second layer (BM1). At block 330, method 300 may identify long rails of the first rails with a first length and short rails of the first rails with a second length that is less than the first length. Also, at block 340, method 300 may separately coupling the long rails and the short rails to the second rails with vias that extend between the first layer (BM0) and the second layer (BM1). In some instances, the first layer (BM0) and the second layer (BM1) may refer to buried metal layers that are formed as buried backside metal layers.

In some implementations, a first set of long rails in the first layer may be coupled to ground (vsse), and a second set of the long rails in the first layer is coupled to a first supply (vddp). Also, a first set of the second rails in the second layer may be coupled to ground (vsse) by way of a via coupled to the first set of the long rails in the first layer, and a second set of the second rails in the second layer is coupled to the first supply (vddp) by way of another via coupled to the second set of the long rails in the first layer. Also, a first set of the short rails in the first layer may be coupled to a second supply (vddce), and a second set of the short rails in the first layer is coupled to a third supply (vddpe). Also, a third set of the second rails in the second layer may be coupled to the second supply (vddce) by way of a via coupled to the first set of the short rails in the first layer, and a fourth set of the second rails in the second layer is coupled to the third supply (vddpe) by way of another via coupled to the second set of the short rails in the first layer. Also, the first rails have a first width, and the second rails have a second width that is greater than the first width.

In some implementations, method 300 may identify porosity related to the second layer by locating empty space corresponding to spatial gaps for porosity channels inline with the short rails in the first layer, and one or more additional second rails are optionally added in the second layer based on user-defined parameters associated with the porosity. Also, method 300 may obtain user-defined porosity information from the user-defined parameters that are associated with the porosity, and the user-defined porosity information may include channel width and frequency of the second rails. Also, method 300 may provide a physical payout design of a power distribution network grid for routing the power rails underneath the memory instance in accordance with the user-defined parameters and porosity information, and the power distribution network grid may be based on user-defined input related to the porosity channels associated with the first layer. Also, method 300 may select the porosity based on the user-defined parameters associated with shielded signal routing, and method 300 may provide a tighter pitch for the second power rails so as to allow for single track signal routing in association with the user-defined parameters for shielded signal routing.

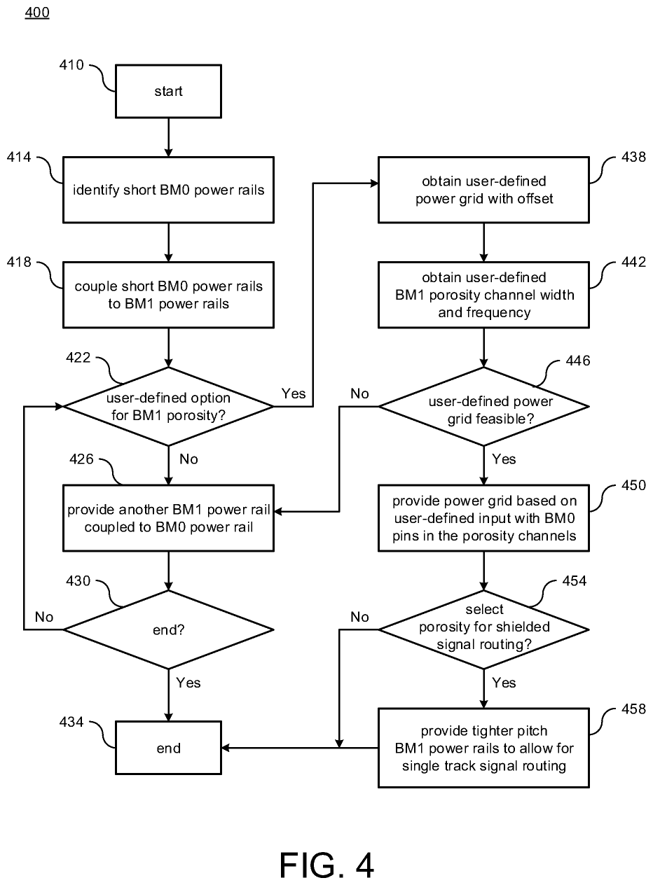

FIG. 4 illustrates a process diagram of a method 400 for providing buried power rail architecture with buried metal in accordance with implementations described herein.

It should be understood that even though method 400 indicates a particular order of operation execution, in some cases, various portions of operations may be executed in a different order, and on different systems. In other cases, additional operations and/or steps may be added to and/or omitted from method 400. Also, method 400 may be implemented in hardware and/or software. If implemented in hardware, method 400 may be implemented with components and/or circuitry, as described in reference to FIGS. 1-3. If implemented in software, method 400 may be implemented as a program or software instruction process configured for providing PDN architecture with buried power rails, as described herein. Also, if implemented in software, instructions related to implementing method 400 may be stored in memory and/or a database. For instance, a computer or various other types of computing devices having a processor and memory may be configured to perform method 400.

As described in reference to FIG. 4, the method 400 may be used for fabricating and/or manufacturing, or causing to be fabricated and/or manufactured, an integrated circuit (IC) that implements the various buried power rail layout schemes and techniques in physical design as described herein so as to thereby provide PDN architecture with buried power rails using various associated devices, components and/or circuitry as described herein.

At block 410, the process flow of method 400 may start, and at block 414, method 400 may identify short BM0 power rails, and at block 418, method 400 may couple the short BM0 power rails to BM1 power rails. In some instances, method 400 may route buried power rails underneath a memory instance, and also, method 400 may identify first rails of the buried power rails disposed in a first layer (BM0) and second rails of the buried power rails disposed perpendicular to the first rails in a second layer (BM1). Also, method 400 may identify long rails of the first rails with a first length and short rails of the first rails with a second length that is less than the first length, and also, method 400 may separately couple the long rails and/or the short rails to the second rails with vias that extend between the first layer (BM0) and the second layer (BM1).

At decision block 422, method 400 may determine whether user-defined options exist for BM1 porosity. If no, then method 400 proceeds to block 426, and if yes, then method 400 proceeds to block 438. In some instances, method 400 may identify porosity related to the second layer by locating empty space corresponding to spatial gaps for porosity channels inline with the short rails in the first layer. Also, method 400 may further determine that one or more additional second rails may be optionally added in the second layer based on user-defined parameters associated with the porosity. Also, at block 426, method 400 may provide another BM1 power rail coupled to the BM0 power rail. Next, at decision block 430, method 400 may decide or determine whether to end the process flow. If no, then method 400 may revert back to decision block 422, and if yes, then method 400 may end at block 434.

At block 438, method 400 may obtain a user-defined power grid with offset, and at block 442, method 400 may obtain (or identify) the user-defined BM1 porosity channel width and/or frequency. Also, at decision block 446, method 400 may determine whether the user-defined power grid is feasible. If no, then method 400 proceeds to block 426, and if yes, then method 400 proceeds to block 450. In some instances, method 400 may obtain user-defined porosity information from the user-defined parameters that are associated with the porosity, and also, the user-defined porosity information may include channel width and frequency of the second rails. In addition, method 400 may provide a physical payout design of a power distribution network (PDN) grid for routing the power rails underneath the memory instance in accordance with the user-defined parameters and porosity information. Further, the power distribution network (PDN) grid may be based on the user-defined input related to the porosity channels associated with the first layer.

At block 450, method 400 may provide a power grid based on user-defined input in reference to BM0 pins in the porosity channels, and at decision block 454, method 400 may determine whether to select porosity for shielded signal routing. If no, then method 400 may end the process at block 434, and if yes, method 400 may proceed to block 458. Then, at block 458, method 400 may provide a tighter pitch to the BM1 power rails so as to allow for single-track signal routing. Next, method 400 may end at block 434. In various instances, method 400 may be configured to select the porosity based on the user-defined parameters that are associated with shielded signal routing, and also, method 400 may provide a tighter pitch for the second power rails so as to allow for single track signal routing in association with the user-defined parameters for shielded signal routing.

In various instances, the buried power rail based implementation methodologies as described herein may be compatible with a standard flow of EDA systems, and output of method 400 may be ported into a standard flow from EDA systems, and vice versa. In FIG. 4, the physical layout design may be separated into PDN-specific implementations for logic synthesis, and also, the physical layout design may be re-assembled into a unified database for additional processing, such as, e.g., floor-planning and placement, after which a database may be separated into various PDN-specific implementations for simulation, synthesis, timing and/or routing. Also, the physical layout design may then be assembled for sign-off. In some instances, FIG. 4 refers to an instance that integrates concepts of a database into standard EDA process flows. With the buried power rail schemes and techniques described herein, a physical layout related database may be separated into PDN-specific implementations at one or more or any or all design stages, or in some relevant combination thereof.

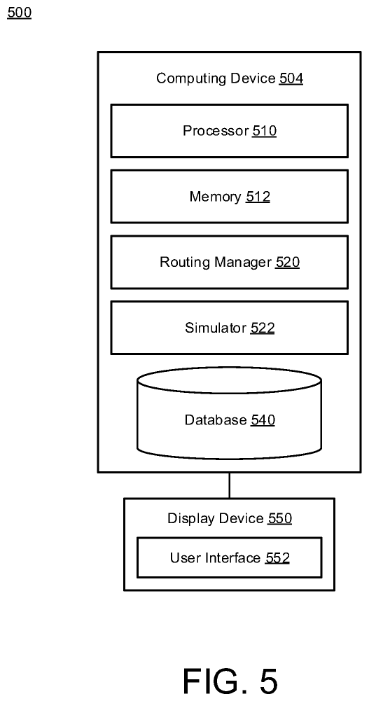

FIG. 5 illustrates a diagram of a system 500 for providing PDN architecture with buried power rails in accordance with various implementations described herein.

In reference to FIG. 5, the system 500 is associated with at least one computing device 504 that is implemented as a special purpose machine configured for implementing buried power rail schemes and techniques in physical design, as described herein. In some instances, the computing device 504 may have any standard element(s) and component(s), including at least one processor(s) 510, memory 512 (e.g., non-transitory computer-readable storage medium), one or more database(s) 540, power, peripherals, along with various other computing elements and/or components that may not be specifically shown in FIG. 5. The computing device 504 may include instructions recorded and/or stored on the non-transitory computer-readable medium 512 that are executable by the at least one processor 510. The computing device 504 may be associated with a display device 550 (e.g., a monitor or other display) that may be used to provide a user interface (UI) 552, such as, e.g., a graphical user interface (GUI). In some instances, the UI 552 may be used to receive parameters and/or preferences from a user for managing, operating, and/or controlling the computing device 504. Thus, in some instances, the computing device 504 may include the display device 550 for providing various output data and information to a user, and also, the display device 550 may include the UI 552 for receiving various input data and information from the user.

In reference to FIG. 5, the computing device 504 may include a routing manager 520 that may be configured to cause the at least one processor 510 to implement various buried power rail schemes and techniques as described herein in reference to FIGS. 1-4, including providing buried power rail architecture related to implementing integrated circuitry in physical design. In some implementations, the routing manager 520 may be implemented in hardware and/or software. For instance, if implemented in software, the routing manager 520 may be stored in memory 512 or database 540. Also, in some instances, if implemented in hardware, the routing manager 520 may refer to a separate processing component that is configured to interface with the processor 510 and/or various other components.

In some instances, the routing manager 520 may be configured to cause the at least one processor 510 to perform various operations, as provided herein in reference to buried power rail schemes and techniques described in FIGS. 1-4. Also, in some instances, the memory 512 has stored thereon instructions that, when executed by the processor 510, cause the processor 510 to perform one or more or all of the following operations.

For instance, the routing manager 520 may be configured to cause the at least one processor 510 to perform various process related operations, including routing buried power rails underneath a memory instance. The process related operations may include identifying first rails of the buried power rails disposed in a first layer and second rails of the buried power rails disposed perpendicular to the first rails in a second layer. The process related operations may include identifying long rails of the first rails with a first length and short rails of the first rails with a second length that is less than the first length. The process related operations may include separately coupling the long rails and the short rails to the second rails with vias that extend between the first layer and the second layer.

The routing manager 520 may be configured to cause the at least one processor 510 to perform various process related operations, including fabricating a memory instance and fabricating a power distribution network having buried power rails routed underneath the memory instance. The process related operations may include fabricating the buried power rails with first rails in a first layer and second rails that are arranged perpendicular to the first rails in a second layer. In some instances, the first rails may have long rails with a first length and short rails with a second length that is less than the first length, and also, the long rails and the short rails are separately coupled to the second rails with vias that extend between the first layer and the second layer.

The routing manager 520 may be configured to cause the at least one processor 510 to perform various process related operations associated with disposing the first rails in the first layer and also disposing the second rails perpendicular to the first rails in the second layer. The process related operations may be associated with identifying the long rails of the first rails with the first length and also identifying the short rails of the first rails with the second length that is less than the first length. The various process related operations may also be associated with separately coupling the long rails and the short rails to the second rails with vias that extend between the first layer and the second layer.

The routing manager 520 may be configured to cause the at least one processor 510 to perform various process related operations associated with identifying porosity related to the second layer, e.g., by locating empty space corresponding to spatial gaps for porosity channels inline with the short rails in the first layer. In some instances, one or more additional second rails may be optionally added in the second layer based on user-defined parameters associated with the porosity. The various process related operations may be associated with obtaining user-defined porosity information from the user-defined parameters that are related to the porosity, and also, the user-defined porosity information includes channel width and/or frequency of the second rails. The various process related operations may be associated with providing a physical payout design of a power distribution network (PDN) grid for routing power rails underneath the memory instance in accordance with the user-defined parameters and porosity information, and also, the power distribution network grid may be based on user-defined input related to the porosity channels associated with the first layer. Also, the various process related operations may be associated with selecting the porosity based on the user-defined parameters associated with shielded signal routing, and providing a tighter pitch for the second power rails so as to allow for single track signal routing in association with the user-defined parameters for shielded signal routing.

In accordance with implementations described herein in reference to FIGS. 1-5, any one or more or all of process related operations performed by the routing manager 520 may be altered, modified, and/or changed so as to provide the various specific embodiments as shown in FIGS. 1-5. Moreover, the buried power rails may be may be formed in various structural semiconductor architecture of a logic block or module having a set of shapes with width and space definitions, and the logic block or module may comprise a physical structure associated with an integrated circuit that is included in a place-and-route (PNR) environment for electronic design automation (EDA) and/or software/hardware related thereto.

Further, in reference to FIG. 5, the computing device 504 may include a simulator 522 that is configured to cause the at least one processor 510 to simulate integrated circuitry and/or generate one or more simulations of integrated circuitry. In various implementations, the simulator 522 may be referred to as a simulating component, and also, the simulator 522 may be implemented in hardware and/or software. If implemented in software, the simulator 522 may be recorded or stored in memory 512 or database 540. If implemented in hardware, the simulator 520 may refer to a separate processing component configured to interface with the processor 510. In some instances, the simulator 522 may be a SPICE simulator that is configured to generate SPICE simulations of the integrated circuitry. Generally, SPICE is an acronym for Simulation Program with Integrated Circuit Emphasis, which is an open source analog electronic circuit simulator. SPICE may refer to a general-purpose software program used by the semiconductor industry to check the integrity of integrated circuit designs and to predict the behavior of integrated circuit designs. Thus, in some implementations, the routing manager 520 may be configured to interface with the simulator 522 so as to generate various timing data based on one or more or all simulations (including, e.g., SPICE simulations) of integrated circuitry that is utilized for analyzing performance characteristics of an integrated circuit including timing data of the integrated circuit. Also, the routing manager 520 may be configured to use one or more or all simulations (including, e.g., SPICE simulations) of the integrated circuit for evaluating operating behavior and conditions thereof.

In various implementations, the computing device 504 may include one or more databases 540 that are configured to store and/or record various data and information related to implementing buried power rail schemes and techniques in physical design. Also, in some instances, the database(s) 540 may be configured to store and record data and information related to integrated circuitry, operating conditions, operating behaviors, timing data and any other related characteristics. Also, the database(s) 540 may be configured to store data and information associated with integrated circuitry and/or timing data in reference to simulation data (including, e.g., SPICE simulation data).

As described herein, various implementations of buried power rail layout schemes and techniques for logic and/or memory applications in physical design may provide various advantages. For instance, schemes and techniques described herein may enhance buried metal power/ground routing of memory instances, e.g., by reducing IR drop. Also, schemes and techniques described herein may optimize enablement of porosity and buried metal for power/ground routing of memory instances. Also, schemes and techniques described herein may reduce power/ground routing congestion so as to improve power/ground global net and related critical global signals. Also, schemes and techniques described herein may be used to provide an automated tool that allows for reducing effort and avoiding human error.

It should be intended that the subject matter of the claims not be limited to various implementations and/or illustrations provided herein, but should include any modified forms of those implementations including portions of implementations and combinations of various elements in reference to different implementations in accordance with the claims. It should also be appreciated that in development of any such implementation, as in any engineering or design project, numerous implementation-specific decisions should be made to achieve developers' specific goals, such as, e.g., compliance with system-related constraints and/or business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Described herein are implementations of a method for routing buried power rails underneath a memory instance. The method may identify first rails of the buried power rails disposed in a first layer and second rails of the buried power rails disposed perpendicular to the first rails in a second layer. The method may identify long rails of the first rails with a first length and short rails of the first rails with a second length that is less than the first length. The method may separately couple the long rails and the short rails to the second rails with vias that extend between the first layer and the second layer.

Described herein are implementations of a method. The method may fabricate a memory instance. The method may fabricate a power distribution network with buried power rails routed underneath the memory instance. The method may also fabricate the buried power rails with first rails in a first layer and second rails arranged perpendicular to the first rails in a second layer. The first rails may include long rails with a first length and short rails with a second length that is less than the first length. Also, the long rails and the short rails may be separately coupled to the second rails with vias that extend between the first layer and the second layer.

Described herein are various implementations of a device having a memory instance and a power distribution network with buried power rails routed underneath the memory instance. The buried power rails may have first rails disposed in a first layer and second rails disposed perpendicular to the first rails in a second layer. The first rails may have long rails with a first length and short rails with a second length that is less than the first length. The long rails and the short rails may be separately coupled to the second rails with vias that extend between the first layer and the second layer.

Reference has been made in detail to various implementations, examples of which are illustrated in accompanying drawings and figures. In the following detailed description, numerous specific details are set forth to provide a thorough understanding of the disclosure provided herein. However, the disclosure provided herein may be practiced without these specific details. In various implementations, well-known methods, procedures, components, circuits and networks have not been described in detail so as not to unnecessarily obscure details of the embodiments.

It should also be understood that, although various terms first, second, etc. may be used herein to describe various elements, these elements should not be limited by these terms. These terms are only used to distinguish one element from another. For instance, a first element could be termed a second element, and, similarly, a second element could be termed a first element. Also, the first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow.

Although the subject matter has been described in language specific to structural features and/or methodological acts, it is to be understood that the subject matter defined in the appended claims is not necessarily limited to the specific features or acts described above. Rather, specific features and acts described above are disclosed as example forms of implementing the claims.

What is claimed is:

1. A method comprising:
routing buried power rails underneath a memory instance;
identifying first rails of the buried power rails disposed in a first layer and second rails of the buried power rails disposed perpendicular to the first rails in a second layer;
identifying long rails of the first rails with a first length and short rails of the first rails with a second length that is less than the first length; and
separately coupling the long rails and the short rails to the second rails with vias that extend between the first layer and the second layer.

2. The method of claim 1, wherein:
a first set of the long rails in the first layer is coupled to ground, and
a second set of the long rails in the first layer is coupled to a first supply.

3. The method of claim 2, wherein:
a first set of the second rails in the second layer is coupled to ground by way of a via coupled to the first set of the long rails in the first layer, and
a second set of the second rails in the second layer is coupled to the first supply by way of another via coupled to the second set of the long rails in the first layer.

4. The method of claim 1, wherein:
a first set of the short rails in the first layer is coupled to a second supply, and
a second set of the short rails in the first layer is coupled to a third supply.

5. The method of claim 4, wherein:
a third set of the second rails in the second layer is coupled to the second supply by way of a via coupled to the first set of the short rails in the first layer, and
a fourth set of the second rails in the second layer is coupled to the third supply by way of another via coupled to the second set of the short rails in the first layer.

6. The method of claim 1, wherein:
the first rails have a first width, and
the second rails have a second width that is greater than the first width.

7. The method of claim 1, further comprising:
identifying porosity related to the second layer by locating empty space corresponding to spatial gaps for porosity channels inline with the short rails in the first layer,
wherein one or more additional second rails are optionally added in the second layer based on user-defined parameters associated with the porosity.

8. The method of claim 7, further comprising:
obtaining user-defined porosity information from the user-defined parameters that are associated with the porosity,
wherein the user-defined porosity information includes channel width and frequency of the second rails.

9. The method of claim 8, further comprising:
providing a physical payout design of a power distribution network grid for routing the power rails underneath the memory instance in accordance with the user-defined parameters and porosity information,
wherein the power distribution network grid is based on user-defined input related to the porosity channels associated with the first layer.

10. The method of claim 9, further comprising:
selecting the porosity based on the user-defined parameters associated with shielded signal routing; and
providing a tighter pitch for the second power rails so as to allow for single track signal routing in association with the user-defined parameters for shielded signal routing.

11. A method comprising:
fabricating a memory instance;
fabricating a power distribution network having buried power rails routed underneath the memory instance; and
fabricating the buried power rails with first rails in a first layer and second rails that are arranged perpendicular to the first rails in a second layer, wherein:
the first rails include long rails with a first length and short rails with a second length that is less than the first length, and
the long rails and the short rails are separately coupled to the second rails with vias that extend between the first layer and the second layer.

12. The method of claim 11, further comprising:
disposing the first rails in the first layer; and
disposing the second rails perpendicular to the first rails in the second layer;
identifying the long rails of the first rails with the first length;
identifying the short rails of the first rails with the second length that is less than the first length; and
separately coupling the long rails and the short rails to the second rails with vias that extend between the first layer and the second layer.

13. The method of claim 12, further comprising:
identifying porosity related to the second layer by locating empty space corresponding to spatial gaps for porosity channels inline with the short rails in the first layer,
wherein one or more additional second rails are optionally added in the second layer based on user-defined parameters associated with the porosity.

14. The method of claim 13, further comprising:
obtaining user-defined porosity information from the user-defined parameters that are associated with the porosity,
wherein the user-defined porosity information includes channel width and frequency of the second rails.

15. The method of claim 14, further comprising:
providing a physical payout design of a power distribution network grid for routing the power rails underneath the memory instance in accordance with the user-defined parameters and porosity information,
wherein the power distribution network grid is based on user-defined input related to the porosity channels associated with the first layer.

16. The method of claim 15, further comprising:
selecting the porosity based on the user-defined parameters associated with shielded signal routing; and
providing a tighter pitch for the second power rails so as to allow for single track signal routing in association with the user-defined parameters for shielded signal routing.

17. A device comprising:
a memory instance; and
a power distribution network having buried power rails routed underneath the memory instance, wherein:
the buried power rails have first rails disposed in a first layer and second rails disposed perpendicular to the first rails in a second layer,
the first rails have long rails with a first length and short rails with a second length that is less than the first length, and
the long rails and the short rails are separately coupled to the second rails with vias that extend between the first layer and the second layer.

18. The device of claim 17, wherein:
the first rails have a first width, and
the second rails have a second width that is greater than the first width.

19. The device of claim 17, wherein:
a first set of the long rails in the first layer is coupled to ground,
a second set of the long rails in the first layer is coupled to a first supply,
a first set of the short rails in the first layer is coupled to a second supply, and
a second set of the short rails in the first layer is coupled to a third supply.

20. The device of claim 19, wherein:
a first set of the second rails in the second layer is coupled to ground by way of a via coupled to the first set of the long rails in the first layer,
a second set of the second rails in the second layer is coupled to the first supply by way of another via coupled to the second set of the long rails in the first layer,
a third set of the second rails in the second layer is coupled to the second supply by way of a via coupled to the first set of the short rails in the first layer, and
a fourth set of the second rails in the second layer is coupled to the third supply by way of another via coupled to the second set of the short rails in the first layer.
